(19) United States
(12) Patent Application Publication
(10) Pub. No.: US 2011/0002764 A1
(43) Pub. Date: Jan. 6, 2011

(54) VEHICLE DRIVER WHEELCHAIR LIFT

(76) Inventors: Scott Alan Darnell, Greenville, IL (US); David Wayne Gotter, Brighton, IL (US)

Correspondence Address: BURDICK LAW FIRM, 3656 WESTERN AVE., SUITE 100, ALTON, IL, 62002, US

(21) Appl. No.: 12/882,145

(22) Filed: Sep. 14, 2010

Related U.S. Application Data
(63) Continuation-in-part of application No. 11/849,283, filed on Sep. 1, 2007, now abandoned.
(60) Provisional application No. 60/841,637, filed on Sep. 1, 2006.

(51) Int. Cl. A61G 3/06; A61G 3/02

(52) U.S. Cl. 414/550; 414/546

(57) ABSTRACT

Disclosed is a vehicle driver wheelchair lift, the lift having a bearing mount fixed to the vehicle that rotationally captures a pivot rod to which a pair of forks are attached by a parallelogram linkage. The rod rotates in the bearing to move the forks horizontally in and out of the vehicle, while the parallelogram linkage expands and contracts to raise and lower the forks. The purpose of the parallel linkage is to allow the forks to move vertically while maintaining a horizontal position. The forks are adapted to engage a pair of horizontal fork receivers fixed to a wheelchair. A vertical linear actuator expands and contracts the linkage to raise and lower the forks vertically. A motor turns the pivot rod to rotate the forks horizontally. In one exemplary embodiment, a lock on the forks secures the receivers and chair on the forks and a sensor signals when the receivers are in locked position suitable for raising and lowering. In one exemplary embodiment, the parallel linkage has outwardly offset lower joints to establish a preset raised position at maximum extension.

### CROSS-REFERENCE TO RELATED APPLICATIONS

This application is a continuation-in-part of and claims the benefit of U.S. patent application 11/849,283, filed on Sep. 1, 2007 and U.S. Provisional Patent Application 60/841,637, filed on Sep. 1, 2006.

### FEDERALLY SPONSORED RESEARCH

Not Applicable.

### BACKGROUND OF THE INVENTION

This invention relates to the field of self-loading or unloading vehicles and more specifically to loading and unloading wheelchairs from vehicles such as classified in class 414, subclass 540.

Persons confined to wheelchairs have limited options pertaining to driving vehicles. Typically, vehicles that are available to disabled persons are necessarily large vehicles, such as vans, which provide internal room sufficient to contain prior art wheelchair lift or ramp devices. Ramp-type devices require the most room inside a vehicle, since a pathway from the ramp—typically on the side of the vehicle—to the driver's seat area of the vehicle must be kept clear.

Some lift devices require a dedicated chair fixed to a lift mechanism of the vehicle. A wheelchair-bound driver of such a vehicle must transfer from his wheelchair to the chair of the vehicle. Likewise, when exiting the vehicle, the driver must transfer back to his wheelchair. Aside from the obvious drawback of having to transfer between chairs, which is time consuming, the driver must also be able to readily store his wheelchair somewhere in the vehicle and must do this after having transferred into the dedicated chair. Normally this means a passenger is required to handle the wheelchair, and that obviously limits the freedom of the driver to drive when and where he wants.

Some other lift devices require specific types of wheelchairs having retractable wheels. To use such a device, the driver must use the wheelchair that comes with these lift devices. But such wheelchairs are cumbersome for normal use since they have extra wheel retracting mechanisms and are not as easy to use outside of the vehicle as conventional wheelchairs.

Some other lift devices require a wheelchair fitted with a lift plate that cooperates with a lift arm of the devices. Engaging the wheelchair with the device can be difficult. Further, such a device provides no means for moving the wheelchair towards the steering wheel of the vehicle when inside the vehicle. As such, if the occupant wishes to be closer to steering wheel or pedals of the vehicle, the user must disengage from the lift arm. Yet disengaging from the lift arm reduces the safety of the device in use, since the wheelchair is then no longer kept in place by the lifting mechanism.

Therefore, there is a need to provide further options for wheelchair confined people such as a better wheelchair lifting device that reduces at least some of the above problems.

### SUMMARY

In a first exemplary embodiment, a bearing is fixed to the vehicle and a pivot arm has a first end rotationally captured within the bearing and free to rotate therein. The pivot arm also has an outer end configured with a fork and a parallelogram linkage to allow vertical movement of the fork while maintaining the fork in a horizontal orientation. The fork on a wheelchair first exemplary embodiment also has a first linear actuator to horizontally rotate the pivot arm to move the wheelchair horizontally in and out of the vehicle, and a second linear actuator to raise and lower the fork to lift the wheelchair into an elevated position high enough that it can be rotated horizontally into the vehicle. The first exemplary embodiment also contains a sensor on the fork since when the wheelchair is in a fully engaged position on the fork and to prevent lifting, rotating and lowering except when the wheelchair is such fully engaged position. The parallelogram lifting mechanism includes a front and rear mounting plate connected to each other by parallel arms. The front mounting plate is connected to the fork and maintains the fork in a horizontal position during vertical lifting, while the rear mounting plate is connected to the pivot arm to maintain that position during rotation. This results in a very secure, compact, and reliable system.

The first exemplary embodiment allows the wheelchair to be easily engaged to the lift device with minimal modification thereto. The first exemplary embodiment will not operate unless the wheelchair is in a proper position on the lifting mechanism. The present invention uses little room within the vehicle and can be used with relatively small vehicles. Further, the present device serves to keep the wheelchair locked into place laterally and vertically within the vehicle when the device is in an inside-vehicle position. In short, the first exemplary embodiment is a better wheelchair lifting device that reduces at least some of the problems described in the background portion of this application. Other features and advantages of the present invention will become apparent from the following more detailed description, taken in conjunction with the accompanying drawings, which illustrate, by way of example, the principles of the invention.

### DRAWINGS

FIG. 1 is a partial perspective exploded view of a first exemplary preferred embodiment of the invention;

FIG. 2 is a partial top plan view of the first exemplary embodiment, illustrating the first exemplary embodiment in an inside position;

FIG. 3 is a partial top plan view of the first exemplary embodiment, illustrating the first exemplary embodiment in an outside position;

FIG. 4 is a left side elevational view of the first exemplary embodiment in a lower position;

FIG. 5 is a partial left-side elevational view of the first exemplary embodiment in a raised position;

FIG. 6 is a left-side elevational view of the first exemplary embodiment, illustrated in an outside position an not engaged with a wheelchair; and

FIG. 7 is a left-side elevational view of the first exemplary embodiment, illustrated in the raised and inside position, and engaged with the wheelchair.

### DETAILED DESCRIPTION

### Exemplary Best Mode (Preferred Exemplary Embodiment)

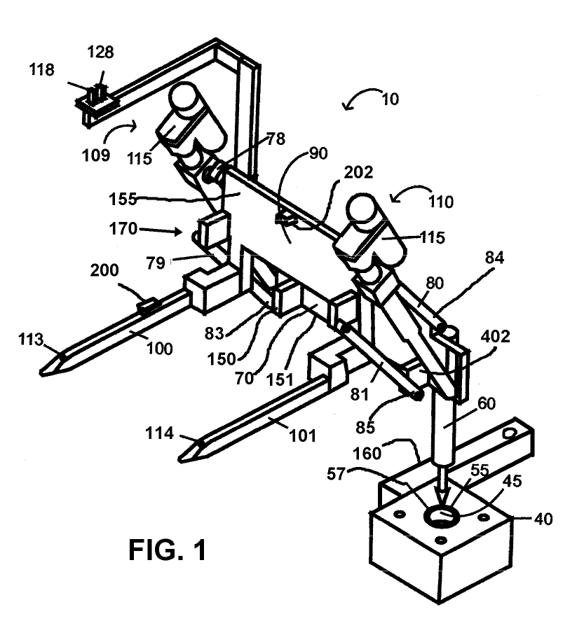

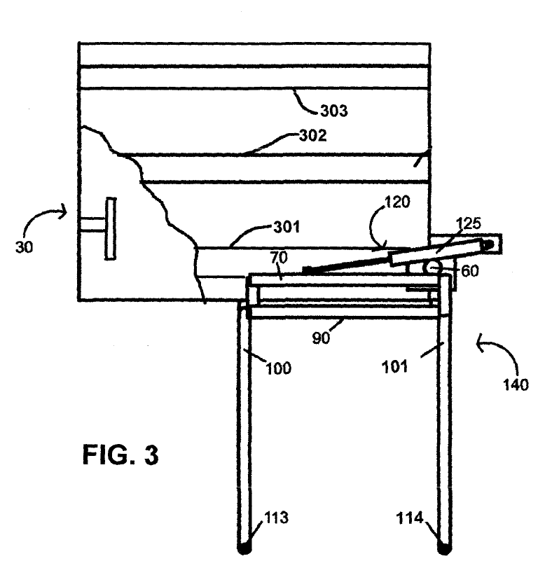

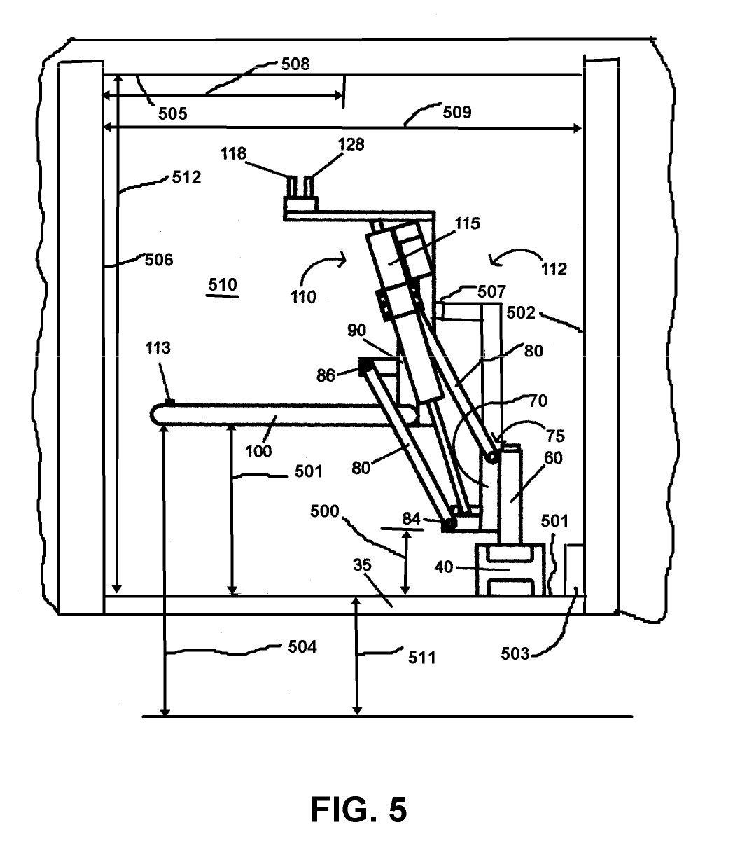

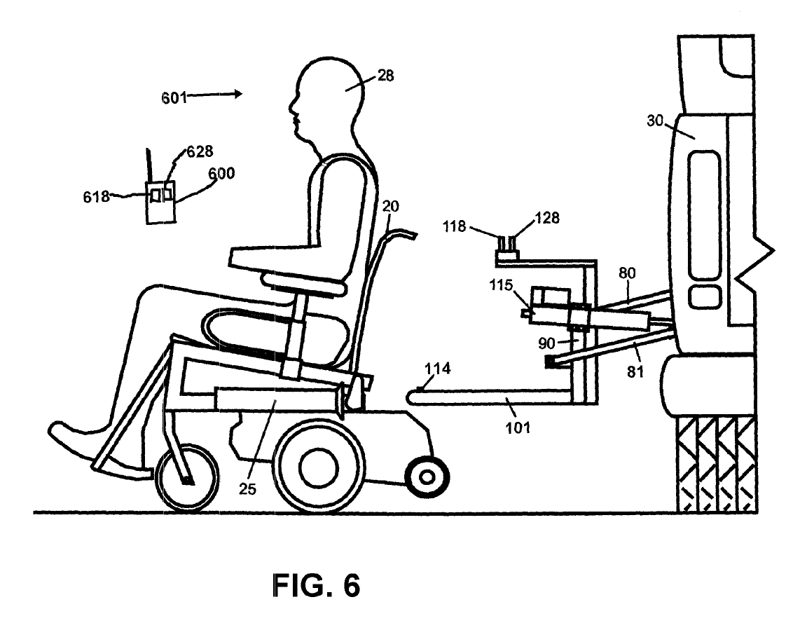

The seven FIGS. 1-7 illustrate a first exemplary embodiment of a system 10 for lifting an driver 28 in a wheelchair 20 into and out of a vehicle 30. FIG. 1 shows system 10 without wheelchair 20 or vehicle 30, while FIG. 5 shows wheelchair 20 in place and system 10 in a first inside position 130 where driver 28 is properly located and oriented to drive vehicle 30. Vehicle 30 is a Dodge, Chevy, or Ford “Quad-Cab” truck, but could be any other vehicle having a sufficiently large side opening. FIG. 3 shows vehicle 30 has a sturdy frame 35 typically including a bar 201, a bar 202 and a bar 203 and other bars (not shown). Vehicle 30 has so-called “suicide-swing” rear door 502 that have a rear hinge (not shown) to open from the front and thus away from a forward door 506, providing a wider opening 510 for wheelchair 20 to enter vehicle 30. For safety purposes, a sensor 200 and a sensor 202 are provided to sense when wheelchair 20 is safely in a position fully engaged with a lock 113 and a lock 114, respectively, on lift fork 100 and lift fork 101 of system 10, in a manner described below.

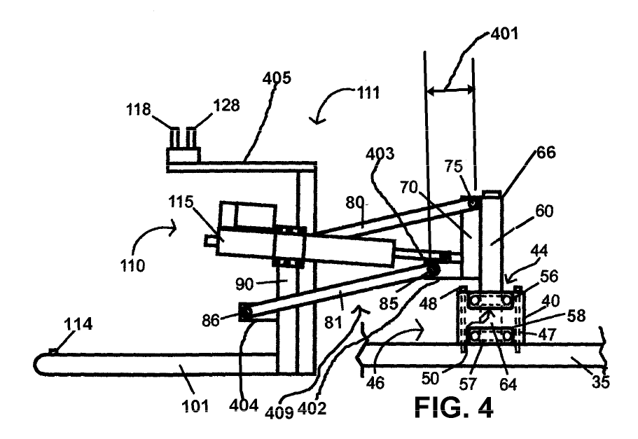

A bearing mount 40 is fixed to a sturdy bar 201 of frame 35 of vehicle 30 and includes a bearing mounting means 44, an inward extension 160 and a vehicle mounting means 46 (FIG. 4). Bearing mounting means 44 is preferably an aperture 45 within bearing mount 40 that is adapted to securely receive a bearing means 50. A pivot rod 60 has an upper portion 66 and a lower end 64, lower end 64 being rotationally captured within bearing means 50. Bearing means 50 comprises an upper ball bearing housing 55 containing a first set of ball bearings 56 and a first inner ring 57 and a matching opposed lower ball bearing housing 54 that rotationally captures a second set of ball bearings 58 and a second inner ring 57. Second inner ring 57 frictionally receives lower end 64 of pivot rod 60. As such, pivot rod 60 is free to rotate horizontally within bearing means 50, but maintains a constant height 500 above a bottom 501 of door opening 700. Both bearing mount 40 and pivot rod 60 are preferably strong rigid metal or strong rigid composite material so as to be able to support the weight of driver 28, wheelchair 20 and system 10 and still easily pivot in a horizontal direction.

Vehicle mounting means 46 is preferably at least two apertures 47 in bearing mount 40 through each of which a bolt 48 may be used to fasten bearing mount 40 to vehicle 30. Other vehicle mounting means 46 may be used as desired, however, such as welding mount 40 to vehicle 30. Preferably bearing mount 40 is fixed to a frame 35 of vehicle 30 at a portion thereof proximate to a driver's side rear door 502, but can also be mounted proximate a passenger side door.

A rigid rear mounting plate 70 is fixed to an upper portion 66 of pivot rod 60 and includes four arm mounting means 75 that are pivotally mounted, one to a rear end 82 of parallel arm 78, one to a rear end 83 of parallel arm 79, one to a rear end 84 of parallel arm 80 and one to a rear end 85 of parallel arm 81. Such arm mounting means 75 are horizontal bolts, although pins, bearings or other fasteners that allows the desired vertical rotation could be substituted. In order to achieve maximum extension of arm 80 and parallel arm 81 in a preferred raised position 112 as seen in FIG. 5, rear end 85 is located forward of rear end 84 by a distance 401 of three inches. This is depicted in FIG. 4. To accomplish this, aright lower extension bar 150 and a left lower extension bar 402 are attached to and extend horizontally forward from a lower portion 151 of rear mounting plate 70 and rear end 85 is attached to a front end 403 of extension bar 402. In order to maintain a parallelogram 409, arm 80 and parallel arm 81 need to be of equal length. Accordingly, an extension bar 404 is attached to a lower portion 410 of front mounting plate 90 and projects forwardly from front mounting plate 90 by 3″. A forward end 86 of parallel arm 81 is attached by an arm mounting means 75 to a front end 407 of extension bar 404. Forward end 86 of parallel arm 81 is pivotally mounted to an upper portion 155 of substantially vertical front mounting plate 90, such that parallel arm 80 on the top, parallel arm 81 on the bottom, rear mounting plate 70 and extension bar 402 on the rear and front mounting plate 90 and extension bar 404 on the front form four sides of a left side parallelogram 409. Parallelogram 409 assures that front mounting plate 90 remains vertical and parallel to vertical rear mounting plate 70. A similar right side parallelogram 170 is also provided. As such, front mounting plate 90 can be raised or lowered with respect to rear mounting plate 70, arms 80 and parallel arm 81 each pivoting vertically and in parallel with respect to rear mounting plate 70 to maintain front mounting plate 90 vertical and thus maintaining fork 100 and fork 101 horizontal. When left fork receiver 25 and a right fork receiver 26 (not shown) are engaged, respectively by fork 100 and fork 101, wheelchair 20 is maintained in a stable and constant upright orientation. Plate 90, bar 402, bar 404, left fork receiver 25, right fork receiver 26, arm 80 and parallel arm 81 are each made from a rigid metal stock or carbon-fiber material, and are each strong enough and attached rigidly enough to support the weight of wheelchair 20 and occupant 28 without bending, buckling or otherwise distorting. This results in a very stable ift mechanism in which a handicapped person can feel comfortable and secure.

A rigid metal or carbon-fiber left fork 100 and rigid metal or carbon-fiber right fork 101 are mounted to, and project horizontally forward from front mounting plate 90 and are adapted to engage, respectively horizontal left fork receiver 25 and horizontal right fork receiver 26 that are fixed to wheelchair 20 (FIG. 4 and FIG. 5) to adapt wheelchair 20 for use with system 10. This is a simple fixed conversion for a wheelchair, as left fork receiver 25 and right fork receiver 26 can be simply located beneath the armrest of wheelchair 20 in a relatively inconspicuous manner out of the way of wheelchair 20 during normal use and do not interfere with folding of wheelchair 20. Left fork receiver 25 and right fork receiver 26 are lightweight metal or carbon-fiber tubes that are fixed to wheelchair 20 with any suitable mounting means such as with bolts, welding, or the like (not shown). Left fork receiver 25 and right fork receiver 26 are laterally spaced the same distance apart as fork 100 and fork 101. Fork 100 and fork 101, moreover, may be adjusted on front mounting plate 90, such as by bolting fork 100 to front mounting plate 90 at a desired location. A pin 113 fixed to fork 100 serves to retain left fork receiver 25 onto fork 100 when fork 100 is in a raised position 112 (FIG. 5). A rear end 700 of left fork receiver 25 and right fork receiver 26 are flared to make left fork receiver 25 and right fork receiver 26 self-correct for slight misalignment when being aligned with fork 100 and fork 101. Fork receiver 25 and right fork receiver 26 pass easily over pin 113 and pin 114, respectively, when fork 100 and fork 101 are lowered. However, pin 113 and pin 114 lock receiver 25 and receiver 26 on fork 100 and fork 101 when fork 100 and fork 101 are raised.

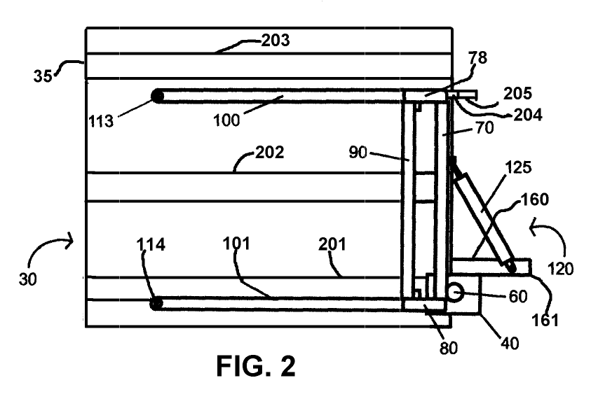

One left vertical linear actuator 109 and one right vertical linear actuator 110 are fixed between rear mounting plate 70 and front mounting plate 90 and are adapted to selectively raise and lower front mounting plate 90, fork 101, and fork 100 with respect to rear mounting plate 70 and vehicle 30. Linear actuator 109 and linear actuator 110 are motor-driven screw drives 115 and linear actuator 120 motor-driven is a motor-driven screw drive 125 as illustrated in FIG. 1 and FIG. 2. An actuator control 118 is adapted to activate linear actuator 110 and is mounted to front mounting plate 90 and is in electrical series with sensor 200 and/or sensor 202, such that an occupant 28 of wheelchair 20 may activate actuator control 118 only when wheelchair 20 is fully seated on fork 100 and fork 101.

In use, rear mounting plate 70, front mounting plate 90, arm 78, arm 79, arm 80, parallel arm 81, fork 100 and fork 101 rotate together horizontally from an inside position 130 inside vehicle 30 to a substantially outside position 140 outside of vehicle 30 about the pivot rod 60. When moving into the inside position 130, linear actuator 110 is in raised position 112. Once inside position 130 is achieved, linear actuator 110 may be lowered slightly as desired by occupant 28, such that front wheels 711 and rear wheels 712 of wheelchair 20 contact floor 702, locking wheelchair 20 in place laterally and vertically in a driving position yet allowing forward movement of wheelchair 20 further under steering wheel 708. When rear mounting plate 70, front mounting plate 90, parallel arm 78, parallel arm 79, arm 80, parallel arm 81, fork 100 and fork 101 are rotated into outside position 140, linear actuator 110 may be contracted to move fork 100 and fork 101 from raised position 112 to a lower position 111.

Preferably, at least one horizontal linear actuator 120 is fixed between vehicle 30 and rear mounting plate 70. Horizontal linear actuator 120 has a motorized screw-drive 125 adapted to selectively rotate front mounting plate 90, arms 80 , fork 100 and fork 101 between inside position 130 and outside position 140, 140 (FIG. 2 and FIG. 3). A second actuator control 128 is adapted to activate horizontal linear actuator 120, and is mounted to actuator control support bar 405 attached atop and extending forwardly from front mounting plate 90 near actuator control 118. As such, occupant 28 may reach both actuator control 118 and actuator control 128 when wheelchair 20 is fully engaged to fork 100 and fork 101, or by remote control when outside of vehicle 30 and not engaged to fork 100 and fork 101.

### Operation of the Exemplary Best Mode

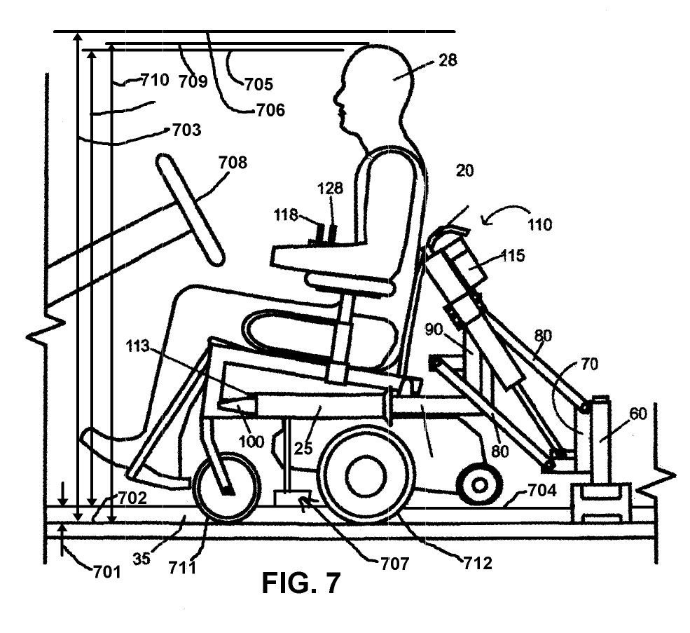

When a solitary wheelchair-confined user 601 approaches vehicle 30, user 601 can use remote control 600 to remotely open front door 506 and remotely activate motor 503 open rear door 502, thus exposing system 10. Next, operator 601 can remotely extend actuator 120 to cause pivot rod 60 rotate to move fork 100 and fork 101 from inside position 130 to outside position 140 and then remotely activate vertical actuator to lower fork 100 and fork 101 from raised position 112 to lower position 111. User 601 then aligns and backs wheelchair 20 and receiver 25 and receiver 26 onto fork 101 and 100, respectively, with flared end 602 assisting in such alignment. Sensor 200 and sensor 202 sense that wheelchair 20 is in place. User 601 then uses actuator control 118 or 618 to raise fork 100 and fork 101 and wheelchair 20 into position 112. When sensor 507 senses contact of front plate 90 sensor 507 enables operation of control 128 and disables control 118 (to prevent lowering during inward rotation). User 601 then activates control 128 to rotate rod 60 clockwise to move fork 100 and fork 101 and wheelchair 20 from outer position 140 to inner position 120 to move wheelchair 20 horizontally into vehicle 30 through opening height 510. For a quad cab pickup truck, user 601 will normally need to duck his head to get under top 505. Completion of movement into the vehicle is sensed by contact of rear plate 70 with sensor 204, which then disables control 128 and enables control 118 so that wheelchair 20 can be lowered onto the floor of vehicle 30 as required by law. Wheelchair 20 can then be moved forward further under steering wheel 708 to a desired final driving position. A floor lock 707, such as Model BL-7317 provided by EZ-Lock can be added to securely hold wheelchair in the desired final driving position. This completes the movement from ground to vehicle in an independent manner so that solitary wheelchair-confined user 601 can employ system 10 to achieve use of a pickup truck without assistance. Likewise, control 600 would also allow system 10 to reverse such movements to return system 10 to move from truck to ground. When rear mounting plate 70, front mounting plate 90, parallel arm 78, parallel arm 79, arm 80, parallel arm 81 and forks 100 are rotated into outside position 140, linear actuator 110 may be extended to move fork 100 and fork 101 from raised position 112 to a lower position 111. Also, once on the ground, control 600 can be used to move system 10 back to inside position 130 after wheelchair 20 exits system 10, thus permitting vehicle 30 and system 10 to be locked and secured from theft or tampering, again by a solitary wheelchair-confined user 601 without assistance. When user 601 desires to again drive the truck, the process is repeated. The sense of freedom and empowerment provided to a wheelchair-confined user 601 in this age of dependence on vehicles for transportation is substantial and of significant benefit to society. This is especially true when so many victims of IED explosions from the Iraq and Afghanistan wars have severe leg injuries necessitating confinement to wheelchairs. And, this system 10 enables use of a pickup truck so user 610 feels much more normal since user 610 does not have to have a typical large modified van. In modern pickup trucks, the door opening height 512 and width (length) 509 are limited by the height and length of the cab. So, a quad cab pickup will be the vehicle of choice so that instead of a standard door opening width 508, a much greater width 509 can be provided. Referring to FIG. 7, for example, the cab of vehicle 30 has a ceiling 706 located at a height 703 of 54″ above a specially sunken floor 702 and a door opening 510 of 49″ height from a bottom 704 to a top 705 and bottom 704 is located a certain distance 511 above the ground. When sitting in wheelchair 20, the height 709 of the top of the inventor's head is a distance 710 of 51″ above the bottom of the wheels, a special sunken floor 702 was used to get a couple of additional inches in floor to ceiling height 703 to make height 703 greater than height 710. Since wheelchair 20 needs to be precisely positioned in order to fit through opening 510 to allow use of such a pickup truck as vehicle 30, tall occupants 28 will need to duck their head to fit in when lifted even just a couple of inches above floor 702 to make height of their head to less than 47″ (49″ less the couple of inches above the floor”. To achieve maximum extension of arm 80 and parallel arm 81 at a precise preferred raised position 112 as seen in FIG. 5, rear end 85 is located forward of rear end 84 by a distance 401 of three inches. This is depicted in FIG. 4. To accomplish this, right lower extension bar 150 and a left lower extension bar 402 are attached to and extends horizontally forward from a lower portion 151 of rear mounting plate 70 and rear end 85 is attached to a front end 403 of extension bar 402. In order to maintain a parallelogram 409, arm 80 and parallel arm 81 need to be of equal length. Accordingly, an extension bar 404 is attached to a lower portion 410 of front mounting plate 90 and projects forwardly from front mounting plate 90 by a distance equal to distance 401. When moving wheelchair 20 into the inside position 130, linear actuator 110 is in raised position 112. Once inside position 130 is achieved, linear actuator 110 may be lowered slightly as desired by occupant 28, such that wheelchair 20 wheels contact floor of vehicle 30 as legally required and enabling locking wheelchair 20 in place in a driving position by use of a wheelchair docking system such as an EZ-LOCK Model BL-7317 sold by EZ Lock Inc. of 2001 Wooddale Blvd., Baton Rouge, La. 70806.

### Alternative Embodiments

While a particular preferred exemplary embodiment of the invention has been illustrated and described, it will be apparent to skilled artisans that various modifications can be made without departing from the spirit and scope of the invention. For example, distance 401 is 3″ in the best mode, but can be within a range of 2″-4″, more preferably within a range of 2.5″ to ⅗″ and even more preferably within a range of 2.8″ to 3.2″, with the precise dimension chosen to achieve the precise height for clearance With suitable modification of a car, system 10 could be adapted to enable user 610 to use a car without assistance. For example the rear driver side passenger door would be switched to open rearward rather than forward and the normal sidepost might be made integral with the rear door so the full driver side could be accessed in similar fashion to the rear opening rear door on vehicle 30. Modification of distance 401 would be coupled with suitable modifications of other dimensions of the parallel linkage. As another alternative, a single vertical linear actuator 110 might be used rather than a pair as in system 10 although a pair would minimize stress on the system and prolong life. By way of further example, a single or pair of vertical screw-drive mechanisms might be used instead of the parallelogram linkage to achieve pure vertical movement of fork 100 and fork 101. A second horizontal screw-drive mechanism might be used to shorten or lengthen the pivot arm. That would have the advantage of (a) allowing forward movement of wheelchair 20 once in the vehicle 30 to put the driver closer to the steering wheel and other driver control devices, (b) allowing rearward movement of wheelchair 20 out from under the steering wheel prior to being rotated out of the vehicle 30 is easy and (c) maintaining the wheelchair 20 engaged with the lifting mechanism in all three directions (vertical, lateral and fore and aft). As another example, pin 113 might be replaced by a powered pin that could be lowered out of the way until wheelchair 20 was fully on fork 100 and fork 101 as determined by sensors 200 and 202 and then lifted up to securely lock wheelchair 20 onto fork 100 and fork 101. Various other locking mechanisms might also be substituted. Likewise, various other sensors might be used instead of sensor 200 and sensor 202. For example pin 113 and/or pin 114 might open (i.e. turn off) the power circuit to control 118, 128, 618 and 628 when pin 113 and/or pin 114 is depressed. That would prevent operation of system 10 while left fork receiver 25 and right fork receiver 26 (not shown)were over pin 113 and/or pin 114, so that system 10 could not be operated while the wheelchair 20 was in the process of being backed onto fork 100 and fork 101 until such time as left fork receiver 25 and 26 had cleared pin 113 and/or pin 114 and pin 113 and/or pin 114 had raised to block left fork receiver 25 and right fork receiver 26 from coming forwardly off of fork 100 and 101. A suitable release button (not shown) would then be added to release pin 113 and pin 114 for depression to allow left fork receiver 25 and right fork receiver 26 to move forwardly off of fork 100 and fork 101 after lowering. Remote control 600 could then be activated to return system 10 to raised position 112 and then to inside position 130 in vehicle 30 so that vehicle 30 could be locked. While I have found that many injured soldiers might prefer a big “bad-ass” ride like the Quad Cabs noted above, others might be more concerned with fuel economy and want something smaller. Accordingly, other vehicles may be modified to accommodate the system 10 such as, for example, a smaller truck, SUV or crossover or minivan modified by removing the driver seat and making the driver door opening sufficiently large to accommodate a system 10 and wheelchair 20, perhaps with a lowered seat adapted lower or incline the driver sufficiently to fit such vehicle. As a further example, tube-like left fork receiver 25 might be replaced by simple right angle bars or U-bars welded to a frame of wheelchair 20. Also, various types of linear actuator 110, 120 may be used as suitable for the present application. Likewise, pin 113 and pin 114 can be spring-biased and retractable to make passage of fork 25 and right fork receiver 26 over pin 113 and pin 114 even easier. Alternately, however, either linear actuator 110 or linear actuator 120 may be a fluidic cylinder (not shown), either hydraulic or pneumatic depending on the available systems of vehicle 30 or any additional pumps and motors.

### Conclusion and Scope

In conclusion, the reader will see that I have provided a better wheelchair lifting device that makes pickup trucks and the like accessible for wheelchair-confined individuals, and does so in a manner that enables unassisted use. This is a significant benefit to the increasing number of such individuals.

While the above description contains many specificities, these should not be construed as limitations on the scope of the invention, but as exemplifications of the presently preferred embodiments thereof. Accordingly, the exemplary best mode shown is just that, exemplary in order to meet best mode and enablement requirements, and not intended to limit the scope of the invention. For limitations, reference should be had to the following claims which are intentionally broader than the exemplary best mode embodiment or any exemplary alternate embodiment described above and to the legal equivalents of the claims below.

1. A system for lifting a wheelchair into and out of a vehicle, comprising: a bearing mount adapted to be fixed to the vehicle; a bearing held by said mount; a pivot rod having an one end captured in said bearing and a second end horizontally rotatable relative to said bearing mount; a vertical front plate; a parallelogram linkage connecting said second end and said front plate and configured to allow vertical movement of said plate relative to said second end while maintaining said front plate vertical; a pair of horizontal forks mounted to said front plate; a pair of horizontal fork receivers fixed to the wheelchair; at least one vertical linear actuator attached to said front plate for operating said linkage to selectively raise and lower said front plate and forks with respect to the mount; a lock to hold said receivers on said forks during raising and lowering and a sensor attached to at least one of said forks and configured to permit operation of said system only when said receivers are a preset distance onto said forks.

2. The system of claim 1 wherein said receivers are tubes and have a flared rear end.

3. The system of claim 2 wherein said vehicle has a sunken floor for extra interior height.

4. The system of claim 1 further comprising a motor attached to said pivot rod for rotating said forks into and out of said vehicle.

5. The system of claim 4 wherein said sensor is further configured to permit operation of said motor only when said receivers are locked on said forks.

6. The system of claim 5 further comprising a first actuator control carried by said front plate and adapted to activate said linear actuator said control mounted on a support that extends forwardly from said plate sufficiently that an occupant of the wheelchair may reach said first actuator control when the wheelchair is locked on the pair of forks.

8. The system of claim 6 wherein said first actuator control is active only when said sensor permits operation of said system.

9. The system of claim 7 wherein a second actuator control is mounted on said support adjacent said first actuator control and said second actuator control is adapted to activate said motor, whereby an occupant of the wheelchair may reach the second control when the wheelchair is fully engaged to the pair of forks.

10. The system of claim 1 wherein the first linear actuator is a motor-driven screw drive.

11. The system of claim 1 wherein the motor is a motor-driven screw drive.

12. A system for lifting a wheelchair into and out of a vehicle, comprising:
a bearing mount adapted to be fixed to the vehicle;
a bearing held by said mount, said bearing having a vertical axis;
a pivot rod having a first end captured in said bearing and a second end horizontally rotatable relative to said bearing mount;
a vertical front plate;
a connector for connecting said front plate to a wheelchair;
a parallelogram linkage connecting said second end to said front plate and configured to allow vertical movement of said front plate relative to said second end while maintaining said front plate vertical, said linkage having an upper front joint, a lower front joint, an upper rear joint, and a lower rear joint, said lower joints both positioned radially outward from said axis by a distance within the range of from about 2 to about 4 inches;
at least one vertical linear actuator having a front end attached to said front plate adjacent said upper front joint and a rear end attached to said second end adjacent said lower rear joint for operating said linkage to selectively raise and lower said front plate with respect to said second end.

13. The system of claim 12 wherein said connector comprises a pair of horizontal forks mounted to said front plate and a pair of horizontal fork receivers fixed to the wheelchair, said receivers configured to receive said forks so as to support the wheelchair during lifting.

14. A system for lifting a wheelchair into and out of a vehicle, comprising:
a bearing mount adapted to be fixed to the vehicle;
a bearing held by said mount, said bearing having a vertical axis;
a pivot rod having a first end captured in said bearing and a second end horizontally rotatable relative to said bearing mount;
a vertical front plate;
a connector for connecting said front plate to a wheelchair;
a parallelogram linkage connecting said second end to said front plate and configured to allow vertical movement of said front plate relative to said second end while maintaining said front plate vertical, said linkage having an upper front joint, a lower front joint, an upper rear joint, and a lower rear joint;
at least one vertical linear actuator having a front end attached to said front plate adjacent said upper front joint and a rear end attached to said second end adjacent said lower rear joint and selectively extendable and contractible to raise and lower said front plate relative to said second end; and
a motor selectively operable to open rearward and forwardly close a rear side door of said vehicle to provide a longer side opening for entry and exit of said wheelchair.

15. The system of claim 14, further comprising a driver accessible control positioned so as to permit operation of said power extender by a wheelchair-confined driver.

16. The system of claim 14, further comprising a remote control configured to control operation of said power extender.

17. The system of claim 16, wherein said remote control is also configured to control operation of said vertical linear actuator.

18. The system of claim 14, further comprising a horizontal linear actuator connected between said vehicle and said second end to rotate said second end from a first position where said front plate is within said van and facing forward to a second position where said front plate is facing laterally outward.

19. The system of claim 18, further comprising a remote control to control operation of said horizontal linear actuator and said vertical linear actuator.

20. The system of claim 19, wherein said remote control is also configured to control operation of said power extender.
